(19) United States
(12) Patent Application Publication
(10) Pub. No.: US 2024/0397492 A1
(43) Pub. Date: Nov. 28, 2024

(54) METHODS, DEVICES, AND COMPUTER READABLE MEDIUM FOR COMMUNICATION

(71) Applicant: NEC CORPORATION, Tokyo (JP)

(72) Inventors: Lin LIANG, Beijing (CN); Gang WANG, Beijing (CN)

(73) Assignee: NEC CORPORATION, Tokyo (JP)

(21) Appl. No.: 18/696,038

(22) PCT Filed: Sep. 28, 2021
(86) PCT No.: PCT/CN2021/121394

§ 371 Date: Mar. 27, 2024

(51) Int. Cl. H04W 72/0446; H04B 7/06; H04W 72/1268; H04W 72/231

(52) U.S. Cl. CPC H04W 72/0446; H04B 7/0626; H04W 72/1268; H04W 72/231

(57) ABSTRACT

According to embodiments of the present disclosure, solutions on the transport block over multiple slots (TBoMS) are proposed. A terminal device receives a configuration from a network device. The configuration indicates that a transport block is transmitted over a first number of slots. The terminal device determines a start bit point of a circular buffer in a slot within the first number of slots based on a redundancy version start indication, an index of the slot and a predetermined factor. In this way, two parts of the CSI can be decoded independently and it can achieve improved performances.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For example, a technology named “transport block over multiple slots (TBoMS)” has been proposed to enhance coverage. It is worth further studying the TBoMS.

### SUMMARY

In general, example embodiments of the present disclosure provide a solution for communications.

In a first aspect, there is provided a method for communication. The communication method comprises: receiving, at a terminal device and from a network device, a configuration indicating that a transport block is transmitted among a first number of slots; and determining, at the terminal device, a start bit point from a bit selection circular buffer for a slot within the first number of slots based on a redundancy version (RV) start indication, an index of the slot and a predetermined factor.

In a second aspect, there is provided a method for communication. The communication method comprises: transmitting, at a network device and to a terminal device, a configuration indicating that a transport block is transmitted among a first number of slots; and receiving, from the terminal device, a set of selected bits from a bit selection circular buffer in a slot, wherein a start bit point from the bit selection circular buffer for the slot within the first number of slots is determined based on a redundancy version (RV) start indication, an index of the slot and a predetermined factor.

In a third aspect, there is provided a terminal device. The terminal device comprises a processing unit; and a memory coupled to the processing unit and storing instructions thereon, the instructions, when executed by the processing unit, causing the terminal device to perform acts comprising: receiving, from a network device, a configuration indicating that a transport block is transmitted among a first number of slots; and determining, at the terminal device, a start bit point from a bit selection circular buffer for a slot within the first number of slots based on a redundancy version (RV) start indication, an index of the slot and a predetermined factor.

In a fourth aspect, there is provided a network device. The network device comprises a processing unit; and a memory coupled to the processing unit and storing instructions thereon, the instructions, when executed by the processing unit, causing the network device to perform acts comprising: transmitting, at a network device and to a terminal device, a configuration indicating that a transport block is transmitted among a first number of slots; and receiving, from the terminal device, a set of selected bits from a bit selection circular buffer in a slot, wherein a start bit point from the bit selection circular buffer for the slot within the first number of slots is determined based on a redundancy version (RV) start indication, an index of the slot and a predetermined factor.

In a fifth aspect, there is provided a computer readable medium having instructions stored thereon, the instructions, when executed on at least one processor, causing the at least one processor to carry out the method according to any one of the first aspect or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 illustrates a schematic diagram of a circular buffer according to some embodiments of the present disclosure;

FIG. 4 is a flowchart of an example method in accordance with an embodiment of the present disclosure;

FIG. 5 is a flowchart of an example method in accordance with an embodiment of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

Embodiments of the present disclosure may be performed in test equipment, e.g. signal generator, signal analyzer, spectrum analyzer, network analyzer, test terminal device, test network device, channel emulator.

Embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

Traditionally, a transport block (TB) is processing within one slot, including bit length determination within one slot, rate matching within one slot and so on. However, for TBoMS, as the TB is generated among multiple slots, rate matching should also be enhanced to support TBoMS. The term “rate matching” used herein can refer to a procedure to collect number of bits after channel coding. The input bit length before the rate matching can be determined by TB length. The output bit length after the rate matching can be determined by resources allocated for a terminal device for uplink shared channel (UL-SCH). Per slot rate matching means that output bit length is determined per slot for TBoMS. Generally, resources allocated for the terminal device may include resources for UL-SCH, resources for uplink control information. When the terminal device detects a downlink control information (DCI) granting uplink transmission, the terminal device may first decide ratio of resources used for UL-SCH and UCI. Number of channel state information (CSI) bits can depend on channel condition. For two parts CSI reporting, the number of bits for CSI part 1 is fixed and the number of bits for CSI part 2 is determined by information carried in CSI part 1.

Current solution of starting point of rate matching for TBoMS in slot m is determined based on number of bits in bit selection before slot m. However, when two parts CSI report are transmitted together with TBoMS, the number of bits in bit selection for UL-SCH depends on information carried in CSI part 1. The network should decode information in CSI part 1 correctly before decoding TB which may reduce efficiency of system, because it affects multiple slots for TBoMS while similar issue for legacy transmission only affect one slot.

According to embodiments of the present disclosure, solutions on the TBoMS are proposed. A terminal device receives a configuration from a network device. The configuration indicates that a transport block is transmitted over a first number of slots. The terminal device determines a start bit point of a circular buffer in a slot within the first number of slots based on a redundancy version start indication, an index of the slot and a predetermined factor. In this way, two parts of the CSI can be decoded independently and it can achieve improved performances.

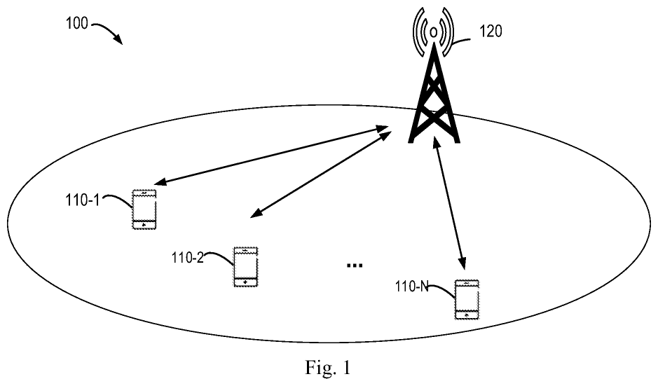

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number. The terminal devices 110 can communication with each other and a link between terminal devices is referred to as sidelink.

The communication system 100 further comprises a network device. In the communication system 100, the network device 120 and the terminal devices 110 can communicate data and control information to each other. The numbers of terminal devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

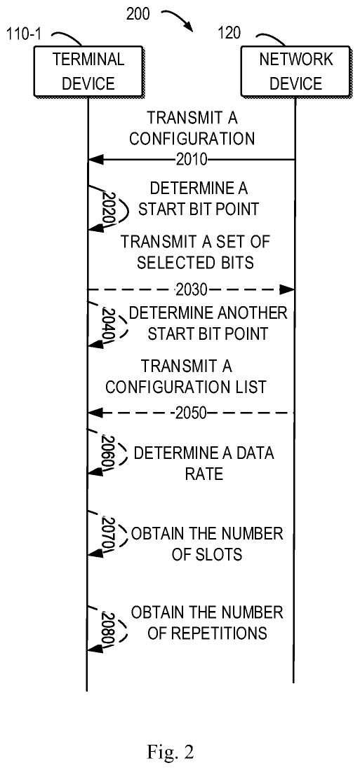

Embodiments of the present disclosure will be described in detail below. Reference is first made to FIG. 2, which shows a signaling chart illustrating process 200 between the terminal device and the network device according to some example embodiments of the present disclosure. Only for the purpose of discussion, the process 200 will be described with reference to FIG. 1. The process 200 may involve the terminal device 110-1 and the network device 120 in FIG. 1.

The network device 120 transmits 2010 a configuration to the terminal device 110-1. The configuration indicates that a TB is transmitted over a first number of slots. The medium access control (MAC) layer may organize the data into the transport block and transmit it to the physical layer. The transport block may comprise up to million bits. When the transport block size exceeds a threshold, the transport block can be divided into multiple code blocks. The code block may comprise up to 8448 bits. Both the transport block and the code block have a cyclic redundancy check (CRC) attached. Due to the difference in the size of the transport block and the code block, the CRC processing scheme suitable for the transport block and that suitable for the code block can be different.

In some embodiments, the network device 120 may transmit resource allocation information to the terminal device 110-1. For example, the network device 120 may transmit information of time domain resource allocation to the terminal device 110-1. In this case, the resource allocation information may comprise the configuration. Alternatively or in addition, the network device 120 may transmit a list of configurations which indicates the time domain resource allocation.

The terminal device 110-1 determines 2020 a start bit point of a circular buffer in a slot within the first number of slots. The start bit point is determined based on a redundancy version (RV) start indication, an index of the slot and a predetermined factor. In this way, when UCI is multiplexing with TBoMS transmission, rate matching starting point irrespective of history information can be decoded independently with CSI reporting in slots within TBoMS which is not used for CSI reporting.

In some embodiments, the predetermined factor may comprise the number of bits for code block with an assumption that no uplink channel information is multiplexing with an uplink shared channel. Alternatively, the predetermined factor may comprise the number of bits for code block with an assumption that X % of the uplink channel information is multiplexing with an uplink shared channel. For example, X can be 20. Alternatively, X can be 10. It should be noted that X can be any suitable number.

In other embodiments, the predetermined factor may comprise the number of bits for code block in the first slot among the first number of slots. Alternatively, the predetermined factor may comprise the number of bits for code block in one slot with a largest value when DCI received from the network device. In other embodiments, the predetermined factor may comprise the number of bits for the code block in the slot, i.e., the current slot. In this way, rate matching starting point using m*E can utilize coded bits as much as possible which can achieve the best performance.

Only as an example, the predetermined factor can be determined based on the procedure shown in Table 1 below. It should be noted that Table 1 is only an example.

```
TABLE 1
Denoting by E, the rate matching output sequence length for the r-th coded block, where
the value of E, is determined as follows:
  Set j = 0
  for r = 0 to C−1
    if the r-th coded block is not scheduled for transmission as indicated by CBGTI according to Clause
      5.1.7.2 for DL-SCH and 6.1.5.2 for UL-SCH in [6, TS 38.214]
      Eᵣ = 0;
    else
      if j ≤ C′−mod(G/(N_{L}·Qₘ),C′)−1
        ${E}_{r} = {N}_{L} \cdot {Q}_{m} \cdot ⌊ \frac{G}{{N}_{L} \cdot {Q}_{m} \cdot {C}^{′}} ⌋ ;$
      else
        ${E}_{r} = {N}_{L} \cdot {Q}_{m} \cdot ⌈ \frac{G}{{N}_{L} \cdot {Q}_{m} \cdot {C}^{′}} ⌉ ;$
      end if
      j = j + 1;
    end if
  end for
where
    N_{L} is the number of transmission layers that the transport block is mapped onto;
    Qₘ is the modulation order;
    G is the total number of coded bits available for transmission of the transport block;
    C′=C if CBGTI is not present in the DCI scheduling the transport block and C′ is the number of
    scheduled code blocks of the transport block if CBGTI is present in the DCI scheduling the
    transport block.
Denote by rv_{id} the redundancy version number for this transmission (rv_{id} = 0, 1, 2 or 3),
the rate matching output bit sequence eₖ, k = 0,1,2,...,E−1, is generated as follows, where k₀
is given by Table 5.4.2.1-2 according to the value of rv_{id} and LDPC base graph:
  k = 0;
  j = 0 for non-TBoMS transmission or j = m*E′ for TBoMS transmission, where m is the available slot
    index within TBoMS resources starting from 0 and E′ is length for the r-th code block;
  while k < E
    if d₍ₖ_{₀}_{+j)modN}_{_{cb}} ≠ < NULL>
      eₖ = d₍ₖ_{₀}_{+j)modN}_{_{cb}} ;
      k = k + 1;
    end if
    j = j + 1;
  end while
```

TABLE 5.4.2.1-2
Starting position of different redundancy versions, k₀

| | k₀ | |
|---|---|---|
| rv_{id} | LDPC base graph 1 | LDPC base graph 2 |
| 0 | 0 | 0 |
| 1 | $⌊ \frac{17 {N}_{cb}}{66 {Z}_{c}} ⌋ {Z}_{c}$ | $⌊ \frac{13 {N}_{cb}}{50 {Z}_{c}} ⌋ {Z}_{c}$ |
| 2 | $⌊ \frac{33 {N}_{cb}}{66 {Z}_{c}} ⌋ {Z}_{c}$ | $⌊ \frac{25 {N}_{cb}}{50 {Z}_{c}} ⌋ {Z}_{c}$ |
| 3 | $⌊ \frac{56 {N}_{cb}}{66 {Z}_{c}} ⌋ {Z}_{c}$ | $⌊ \frac{43 {N}_{cb}}{50 {Z}_{c}} ⌋ {Z}_{c}$ |

The term “redundancy version” used herein can refer a parameter which tells the terminal device about amount of redundancy added into the codeword. Each redundancy version corresponds to a certain column position of the base graph which divides the base graph excluding punctured two columns into four chunks. The index of the slot may start from a predetermined number. For example, the index of the slot can start from zero. It should be noted that the index of the slot can start from any proper number.

In some embodiments, the start bit point can be determined by:

$${k}_{m} = ( RV + m \times E ) mod {N}_{buffer} , \qquad ( 1 )$$

where kₘ represents the start bit point, RV represents the RV start indication, m represents the index of the slot, NA_{buffer} represents a length of the bit selection circular buffer, and E represents the predetermined factor. It should be noted that the start bit point can be determined in any proper way, not limited to the example above.

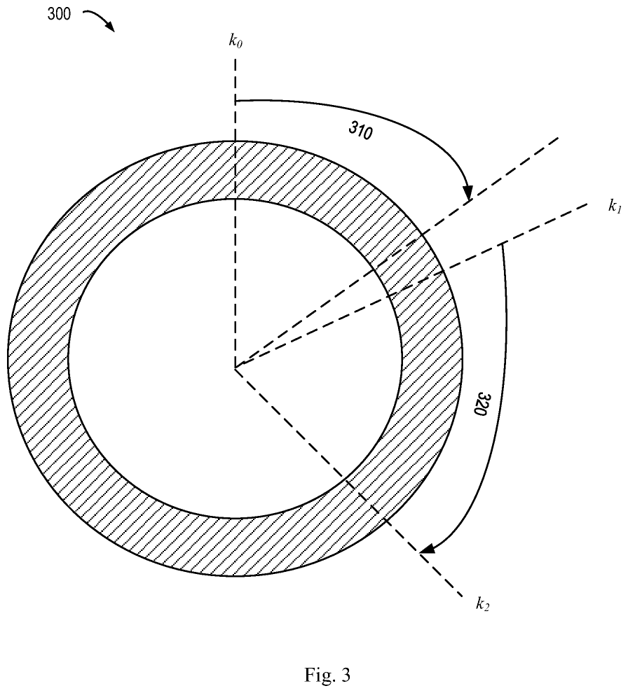

For example, referring to FIG. 3, if the index of the slot is 0, the start bit point “k₀” can be 0. In this case, the terminal device 110-1 may select the set of bits 310. If the index of the slot is 1, the start bit point “k₁” can be E. In this case, the terminal device 110-1 may select the set of bits 320. Further, as shown in FIG. 3, bits in slot 0 is less than that in slot 1 due to CSI reporting in slot 0.

The terminal device 110-1 may transmit 2030 the set of selected bits to the network device 120. For example, the terminal device 110-1 may transmit the set of bits 310 in the slot 0. The terminal device 110-1 may transmit the set of bits 320 in the slot 1.

The terminal device 110-1 may determine 2040 another start bit point of bit selection in a subsequent slot. For example, if no bits are transmitted in the slot after the bit selection, the terminal device 110-1 may determine the other slot start bit point in the subsequent slot from an end bit of the bit selection in the slot. In other words, if available slot m is omitted due to collision with other channels and/or signals, no bits will be transmitted in slot m, but it counts for bit selection which means starting bit of bit selection in slot m+1 is not right after ending bit of bit selection in slot m−1 but skip the length of bits of bit selection in slot m. For example, referring to FIG. 3, the start bit point k₂ of the slot 2 can be after the end bit of the set of bits 320, even though the set of bits 320 cannot be transmitted.

The terminal device 110-1 may determine data rate for a cell group or per carrier. The data rate can be determined by diving total data volume of all TB(s) by transmission duration. In some embodiments, the terminal device 110-1 may determine 2060 a data rate of the TB. For example, the data rate can be determined based on a size of the TB, a total number of code blocks for the TB and a number of scheduled code blocks for the TB. In some embodiments, if the data rate is below a threshold data rate, the terminal device 110-1 may handle the uplink transmission of the TB. Alternatively, if the data rate exceeds the threshold data rate, the terminal device 110-1 may not handle the uplink transmission of the TB. The threshold data rate can be configured by the network device 120 or predetermined. In this way, even with higher TB size, TBoMS is transmitted over multiple slots which results in relative smaller processing bits per slots. When determining transmitting data rate, adjustment on legacy data rate can support larger data rate meanwhile not increase UE processing capability.

In some embodiments, the data rate can be determined by:

$$V = \frac{TBS \times C 1}{N \times C} , \qquad ( 2 )$$

where V represents the data rate, TBS represent the size of the transport block, C1 represents the number of scheduled code blocks, C represents the total number of code blocks, and N represents the first number of slots. It should be noted that the data rate can be determined in any proper way, not limited to the example above.

For example, within a cell group, the terminal device 110-1 may not be required to handle physical uplink shared channel(s) (PUSCH(s)) transmissions in slot sⱼ in serving cell-j, and for j=0, 1, 2 . . . J−1, slot sⱼ overlapping with any given point in time, if the following condition is not satisfied at that point in time:

$${\sum }_{j = 0}^{J - 1} \frac{{\sum }_{m = 0}^{M - 1} {V}_{j , m}}{{T}_{slot}^{μ ( j )}} \leq DataRate ,$$

where −J is the number of configured serving cells belong to a frequency range
for the j-th serving cell,
   M is the number of TB(s) transmitted in slot-sⱼ. For PUSCH repetition Type B, each actual repetition is counted separately.
   Tₛₗₒₜ^{u(j)}=10⁻³/2^{μ(j)}, where μ(j) is the numerology for PUSCH(s) in slot sⱼ of the j-th serving cell.
   for the m-th TB,

$${V}_{j , m} = {C}^{′} \cdot ⌊ \frac{A}{C * N} ⌋$$

A is the number of bits in the transport block as defined in Clause 6.2.1 [5, TS 38.212]
C is the total number of code blocks for the transport block defined in Clause 5.2.2 [5, TS 38.212].
C is the number of scheduled code blocks for the transport block as defined in Clause 5.4.2.1 [5, TS 38.212]
DataRate [Mbps] is computed as the maximum data rate summed over all the carriers in the frequency range for any signaled band combination and feature set consistent with the configured servings cells, where the data rate value is given by the formula in Clause 4.1.2 in [13, TS 38.306], including the scaling factor f(i).

For a j-th serving cell, if higher layer parameter processingType2Enabled of PUSCH-ServingCellConfig is configured for the serving cell and set to ‘enable’, or if at least one I_{MCS}>W for a PUSCH, where W=28 for MCS tables 5.1.3.1-1 and 5.1.3.1-3 in [TS 38.212], and W=27 for MCS tables 5.1.3.1-2, 6.1.4.1-1, and 6.1.4.1-2 in [TS 38.212], or if it is an actual repetition for PUSCH repetition Type B, the terminal device 110-1 is not required to handle PUSCH transmissions, if the following condition is not satisfied:

$$\frac{{\sum }_{m = 0}^{M - 1} {V}_{j , m}}{L \times {T}_{s}^{μ}} \leq DataRateCC$$

where
L is the number of symbols assigned to the PUSCH
M is the number of TB in the PUSCH

$${T}_{s}^{μ} = \frac{{10}^{- 3}}{{2}^{μ} \cdot {N}_{symb}^{slot}}$$

where μ is the numerology of the PUSCH
for the m-th TB,

$${V}_{j , m} = {C}^{′} \cdot ⌊ \frac{A}{C} ⌋$$

A is the number of bits in the transport block as defined in Clause 6.2.1 [5, TS 38.212]
C is the total number of code blocks for the transport block defined in Clause 5.2.2 [5, TS 38.212]
C′ is the number of scheduled code blocks for the transport block as defined in Clause 5.4.2.1 [5, TS 38.212]
DataRateCC [Mbps] is computed as the maximum data rate for a carrier in the frequency band of the serving cell for any signaled band combination and feature set consistent with the serving cell, where the data rate value is given by the formula in Clause 4.1.2 in [13, TS 38.306], including the scaling factor f(i)
each actual repetition for PUSCH repetition type B is treated as one PUSCH.

In some embodiments, the network device 120 may configure a first value which indicates the first number of slots for one TB. In addition, the network device 120 may determine the number of repetitions for the TB and configured a second value which indicates the number of repetitions for the TB.

For example, in some embodiments, the network device 120 may jointly code the first value and second value as part of a time domain resource allocation in a configuration list. The configuration list can comprise entries of DCI code point, which means that a code indication in DCI corresponds to a configuration in the list. In this case, the network device 120 may transmit a configuration list which comprises the time domain resource application. The configuration list can be transmitted via RRC signaling. The time domain resource allocation can comprise a set of first numbers and a set of number of repetitions for the TB. The network device 120 may transmit DCI which comprises a code indication. In this case, the terminal device 110-1 may determine the first number of slots for one TB and the number of repetitions for the TB based on the time domain resource allocation and the code indication. For example, a time domain resource allocation in the configuration list indicates that the first number is 4 and the number for repetitions is 2, and this configuration has a first entry of the DCI code point. Another time domain resource allocation in the configuration list indicates that the first number is 8 and the number for repetitions is 4, and this configuration has a second entry of the DCI code point. If the code indication corresponds to the first entry, the terminal device 110-1 may determine the first number is 4 and the number for repetitions is 2. In this way, it can provide best flexibility of signaling indication. More flexible dynamic indication can adapt channel condition variation rapidly.

Alternatively, the network device 120 may code one of: the first number of slots for one TB and the number of repetitions for the TB as a part of the time domain resource allocation in the configuration list. The network device 120 may code the other one regardless of the configuration list. The time domain resource allocation may comprise one of: a set of first numbers or a set of numbers of repetitions for the transport block. The network device 120 may transmit a code indication in DCI. The terminal device 110-1 may determine, based on the code indication, one of the first number or a sixth number of repetitions from the time domain resource allocation. The other one can be configured statically. In this way, it can provide better trade-off between dynamic indication and static indication. One value is dynamic indicated and another is static indicated will on one hand provide flexibility and on the other hand reduce overhead.

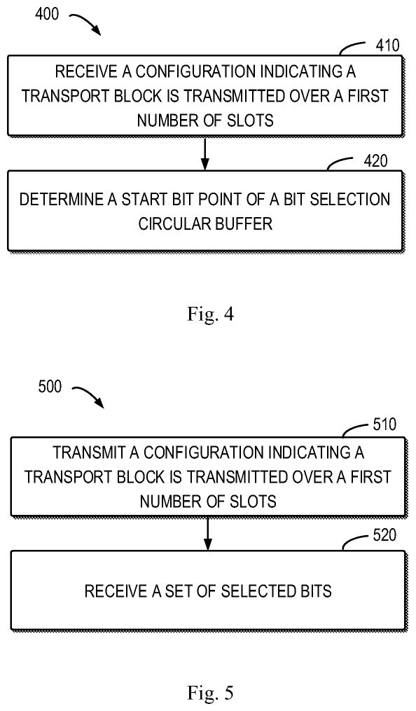

FIG. 4 shows a flowchart of an example method 400 in accordance with an embodiment of the present disclosure. The method 400 can be implemented at any suitable devices. Only for the purpose of illustrations, the method 400 can be implemented at a terminal device 110-1 as shown in FIG. 1.

At block 410, the terminal device 110-1 receives a configuration from the network device 120. The configuration indicates that a TB is transmitted over a first number of slots. The medium access control (MAC) layer may organize the data into the transport block and transmit it to the physical layer. The transport block may comprise up to million bits. When the transport block size exceeds a threshold, the transport block can be divided into multiple code blocks. The code block may comprise up to 8448 bits. Both the transport block and the code block have a cyclic redundancy check (CRC) attached. Due to the difference in the size of the transport block and the code block, the CRC processing scheme suitable for the transport block and that suitable for the code block can be different.

In some embodiments, the terminal device 110-1 may receive resource allocation information from the network device 120. For example, the network device 120 may transmit information of time domain resource allocation to the terminal device 110-1. In this case, the resource allocation information may comprise the configuration. Alternatively or in addition, the terminal device 110-1 may receive a list of configurations which indicates the time domain resource allocation.

At block 420, the terminal device 110-1 determines a start bit point of a circular buffer in a slot within the first number of slots. The start bit point is determined based on a RV start indication, an index of the slot and a predetermined factor. In this way, when UCI is multiplexing with TBoMS transmission, rate matching starting point irrespective of history information can be decoded independently with CSI reporting in slots within TBoMS which is not used for CSI reporting.

In some embodiments, the predetermined factor may comprise the number of bits for code block with an assumption that no uplink channel information is multiplexing with an uplink shared channel. Alternatively, the predetermined factor may comprise the number of bits for code block with an assumption that X % of the uplink channel information is multiplexing with an uplink shared channel. For example, X can be 20. Alternatively, X can be 10. It should be noted that X can be any suitable number.

In other embodiments, the predetermined factor may comprise the number of bits for code block in the first slot among the first number of slots. Alternatively, the predetermined factor may comprise the number of bits for code block in one slot with a largest value when DCI received from the network device. In other embodiments, the predetermined factor may comprise the number of bits for the code block in the slot, i.e., the current slot. In this way, rate matching starting point using m*E can utilize coded bits as much as possible which can achieve the best performance.

The term “redundancy version” used herein can refer a parameter which tells the terminal device about amount of redundancy added into the codeword. Each redundancy version corresponds to a certain column position of the base graph which divides the base graph excluding punctured two columns into four chunks. The index of the slot may start from a predetermined number. For example, the index of the slot can start from zero. It should be noted that the index of the slot can start from any proper number.

In some embodiments, the terminal device 110-1 may transmit the set of selected bits to the network device 120. In addition, the terminal device 110-1 may determine another start bit point of bit selection in a subsequent slot. For example, if no bits are transmitted in the slot after the bit selection, the terminal device 110-1 may determine the other slot start bit point in the subsequent slot from an end bit of the bit selection in the slot. In other words, if available slot m is omitted due to collision with other channels and/or signals, no bits will be transmitted in slot m, but it counts for bit selection which means starting bit of bit selection in slot m+1 is not right after ending bit of bit selection in slot m−1 but skip the length of bits of bit selection in slot m.

In some embodiments, the terminal device 110-1 may determine data rate for a cell group or per carrier. The data rate can be determined by diving total data volume of all TB(s) by transmission duration. In some embodiments, the terminal device 110-1 may determine a data rate of the TB. For example, the data rate can be determined based on a size of the TB, a total number of code blocks for the TB and a number of scheduled code blocks for the TB. In some embodiments, if the data rate is below a threshold data rate, the terminal device 110-1 may handle the uplink transmission of the TB. Alternatively, if the data rate exceeds the threshold data rate, the terminal device 110-1 may not handle the uplink transmission of the TB. The threshold data rate can be configured by the network device 120 or predetermined. In this way, even with higher TB size, TBoMS is transmitted over multiple slots which results in relative smaller processing bits per slots. When determining transmitting data rate, adjustment on legacy data rate can support larger data rate meanwhile not increase UE processing capability.

In some embodiments, the network device 120 may configure a first value which indicates the first number of slots for one TB. In addition, the network device 120 may determine the number of repetitions for the TB and configured a second value which indicates the number of repetitions for the TB.

For example, in some embodiments, the first value and second value can be jointly coded as part of a time domain resource allocation in a configuration list. The configuration list can comprise entries of DCI code point, which means that a code indication in DCI corresponds to a configuration in the list. In this case, the terminal device 110-1 receive transmit a configuration list which comprises the time domain resource application. The configuration list can be transmitted via RRC signaling. The time domain resource allocation can comprise a set of first numbers and a set of number of repetitions for the TB. The network device 120 may transmit DCI which comprises a code indication. In this case, the terminal device 110-1 may determine the first number of slots for one TB and the number of repetitions for the TB based on the time domain resource allocation and the code indication. In this way, it can provide best flexibility of signaling indication. More flexible dynamic indication can adapt channel condition variation rapidly.

Alternatively, one of: the first number of slots for one TB and the number of repetitions for the TB can be coded as a part of the time domain resource allocation in the configuration list. The other one may be coded regardless of the configuration list. The time domain resource allocation may comprise one of: a set of first numbers or a set of numbers of repetitions for the transport block. The network device 120 may transmit a code indication in DCI. The terminal device 110-1 may determine, based on the code indication, one of the first number or a sixth number of repetitions from the time domain resource allocation. The other one can be configured statically.

Only as an example, the number of repetitions for the TB can be statically configured. In this case, the time domain resource allocation may comprise a set of first numbers. The terminal device 110-1 may determine the first number of slots for one TB based on the time domain resource allocation and the code indication. For example, a time domain resource allocation in the configuration list indicates that the first number is 4, and this configuration has a first entry of the DCI code point. Another time domain resource allocation in the configuration list indicates that the first number is 8, and this configuration has a second entry of the DCI code point. If the code indication corresponds to the first entry, the terminal device 110-1 may determine the first number is 4.

Alternatively, the first number can be statically configured. In this case, the time domain resource allocation may comprise a set of numbers for repetitions of the TB. The terminal device 110-1 may determine the number for repetitions of the TB based on the time domain resource allocation and the code indication.

In this way, it can provide better trade-off between dynamic indication and static indication. One value is dynamic indicated and another is static indicated will on one hand provide flexibility and on the other hand reduce overhead.

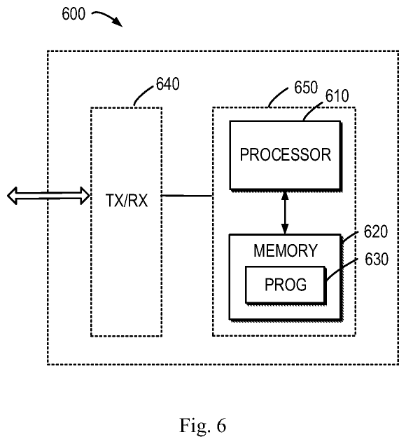

FIG. 5 shows a flowchart of an example method 500 in accordance with an embodiment of the present disclosure. The method 500 can be implemented at any suitable devices. Only for the purpose of illustrations, the method 500 can be implemented at a network device 120 as shown in FIG. 1.

At block 510, the network device 120 transmits a configuration to the terminal device 110-1. The configuration indicates that a TB is transmitted over a first number of slots. The medium access control (MAC) layer may organize the data into the transport block and transmit it to the physical layer. The transport block may comprise up to million bits. When the transport block size exceeds a threshold, the transport block can be divided into multiple code blocks. The code block may comprise up to 8448 bits. Both the transport block and the code block have a cyclic redundancy check (CRC) attached. Due to the difference in the size of the transport block and the code block, the CRC processing scheme suitable for the transport block and that suitable for the code block can be different.

In some embodiments, the network device 120 may transmit resource allocation information to the terminal device 110-1. For example, the network device 120 may transmit information of time domain resource allocation to the terminal device 110-1. In this case, the resource allocation information may comprise the configuration. Alternatively or in addition, the network device 120 may transmit a list of configurations which indicates the time domain resource allocation.

At block 520, the network device 120 receives the set of selected bits to from terminal device 110-1.

In some embodiments, the network device 120 may configure a first value which indicates the first number of slots for one TB. In addition, the network device 120 may determine the number of repetitions for the TB and configured a second value which indicates the number of repetitions for the TB.

For example, in some embodiments, the network device 120 may jointly code the first value and second value as part of a time domain resource allocation in a configuration list. The configuration list can comprise entries of DCI code point, which means that a code indication in DCI corresponds to a configuration in the list. In this case, the network device 120 may transmit a configuration list which comprises the time domain resource application. In this way, it can provide best flexibility of signaling indication. More flexible dynamic indication can adapt channel condition variation rapidly.

Alternatively, the network device 120 may code one of: the first number of slots for one TB and the number of repetitions for the TB as a part of the time domain resource allocation in the configuration list. The network device 120 may code the other one regardless of the configuration list. The network device 120 may then transmit the configuration list and an indication regarding the number of repetitions for the TB to the terminal device 110-1. In this way, it can provide better trade-off between dynamic indication and static indication. One value is dynamic indicated and another is static indicated will on one hand provide flexibility and on the other hand reduce overhead.

In some embodiments, a terminal device comprises circuitry configured to receive, from a network device, a configuration indicating that a transport block is transmitted over a first number of slots; and determine, at the terminal device, a start bit point from a bit selection circular buffer for a slot within the first number of slots based on a redundancy version (RV) start indication, an index of the slot and a predetermined factor.

In some embodiments, the terminal device comprises circuitry configured to determine the start point by: determining the start bit point by kₘ=(RV+m×E) mod N_{buffer}, wherein kₘ represents the start bit point, R V represents the RV start indication, m represents the index of the slot, N represents a length of the bit selection circular buffer, and E represents the predetermined factor.

In some embodiments, the terminal device comprises circuitry further configured to transmit, to the network device, a set of selected bits from the bit selection circular buffer in the slot.

In some embodiments, the index of the slot starts from a predetermined number.

In some embodiments, the terminal device comprises circuitry further configured to in accordance with a determination that no bits are transmitted in the slot after bit selection for the slot, determine another start bit point of bit selection for a subsequent slot from an end bit of the bit selection for the slot.

In some embodiments, the predetermined factor comprises one of: a second number of bits for code block with an assumption that no uplink channel information is multiplexing with an uplink shared channel, a third number of bits for the code block in a first slot among the first number of slots, a fourth number of bits for the code block in one slot with a largest value when downlink control information (DCI) received from the network device, or a fifth number of bits for the code block in the slot.

In some embodiments, the terminal device comprises circuitry further configured to determine a data rate of the transport block based on a size of the transport block, a total number of code blocks for the transport block and a number of scheduled code blocks for the transport block; and in accordance with a determination that the determined data rate exceeds a threshold data rate, cause a transmission of the transport block to be skipped.

In some embodiments, the terminal device comprises circuitry further configured to determine the data rate by:

$$determining the data rate by = \frac{TBS \times C 1}{N \times C} ,$$

wherein V represents the data rate, TBS represent the size of the transport block, C1 represents the number of scheduled code blocks, C represents the total number of code blocks, and N represents the first number of slots.

In some embodiments, the terminal device comprises circuitry further configured to receive, from the network device, a configuration list which comprises a time domain resource allocation; and obtain, at the terminal device, the first number of slots and a sixth number of repetitions for the transport block based on the time domain resource allocation.

In some embodiments, the terminal device comprises circuitry further configured to obtain a configuration list which comprises a time domain resource allocation, wherein the time domain resource allocation comprises a set of first numbers and a set of numbers of repetitions for the transport block; receive, from the network device, a code indication in downlink control information; and determine, based on the code indication, the first number and a sixth number of repetitions from the time domain resource allocation.

In some embodiments, the terminal device comprises circuitry further configured to obtain, from the network device, a configuration list which comprises a time domain resource allocation, wherein the time domain resource allocation comprises one of: a set of first numbers or a set of numbers of repetitions for the transport block; receive, from the network device, a code indication in downlink control information; determine, based on the code indication, one of: the first number or a sixth number of repetitions from the time domain resource allocation; and obtain at the terminal device, the other one of: the first number or a sixth number of repetitions from the time domain resource allocation.

In some embodiments, a network device comprises circuitry configured to transmit, to a terminal device, a configuration indicating that a transport block is transmitted over a first number of slots; and receive, from the terminal device, a set of selected bits from a bit selection circular buffer in a slot, wherein a start bit point from the bit selection circular buffer for the slot within the first number of slots is determined based on a redundancy version (RV) start indication, an index of the slot and a predetermined factor.

In some embodiments, the index of the slot starts from a predetermined number.

In some embodiments, the predetermined factor comprises one of: a second number of bits for code block with an assumption that no uplink channel information is multiplexing with an uplink shared channel, a third number of bits for the code block in a first slot among the first number of slots, a fourth number of bits for the code block in one slot with a largest value when downlink control information (DCI) received from the network device, or a fifth number of bits for the code block in the slot.

In some embodiments, the network device comprises circuitry further configured to determine, at the network device, a sixth number of repetitions for the transport block; code, at the network device, the first number and the six number as part of a time domain resource allocation in a configuration list, wherein the configuration list comprises entries of downlink control (DCI) code points; and transmit, to the terminal device, the configuration list.

In some embodiments, the network device comprises circuitry further configured to transmit, to the terminal device, a configuration list which comprises a time domain resource allocation, wherein the time domain resource allocation comprises a set of first numbers or a set of numbers of repetitions for the transport block; and transmit, to the terminal device, a code indication in downlink control information, wherein the code indication corresponds to a configuration in the configuration list.

In some embodiments, the network device comprises circuitry further configured to transmitting, to the terminal device, a configuration list which comprises a time domain resource allocation, wherein the time domain resource allocation comprises one of: a set of first numbers or a set of numbers of repetitions for the transport block; receiving, from the network device, a code indication in downlink control information; and determining, based on the code indication, one of: the first number or a sixth number of repetitions from the time domain resource allocation.

FIG. 6 is a simplified block diagram of a device 600 that is suitable for implementing embodiments of the present disclosure. The device 600 can be considered as a further example implementation of the terminal device 110 and the network device 120 as shown in FIG. 1. Accordingly, the device 600 can be implemented at or as at least a part of the terminal device 110.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 620 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between eNBs, Si interface for communication between a Mobility Management Entity (MME)/Serving Gateway (S-GW) and the eNB, Un interface for communication between the eNB and a relay node (RN), or Uu interface for communication between the eNB and a terminal device.

The program 630 is assumed to include program instructions that, when executed by the associated processor 610, enable the device 600 to operate in accordance with the embodiments of the present disclosure, as discussed herein with reference to FIG. 2 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 1550 adapted to implement various embodiments of the present disclosure.

The memory 620 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 4-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

I/We claim:

1. A communication method, comprising:
receiving, at a terminal device and from a network device, a configuration indicating that a transport block is transmitted over a first number of slots; and
determining, at the terminal device, a start bit point from a bit selection circular buffer for a slot within the first number of slots based on a redundancy version (RV) start indication, an index of the slot and a predetermined factor.

2. The method of claim 1, wherein determining the start point comprises:
determining the start bit point by
$${k}_{m} = ( RV + m \times E ) mod {N}_{buffer} ,$$
wherein kₘ represents the start bit point, RV represents the RV start indication, m represents the index of the slot, N_{buffer} represents a length of the bit selection circular buffer, and E represents the predetermined factor.

3. The method of claim 1, further comprising:
transmitting, to the network device, a set of selected bits from the bit selection circular buffer in the slot.

4. The method of claim 1, wherein the index of the slot starts from a predetermined number.

5. The method of claim 1, further comprising:
in accordance with a determination that no bits are transmitted in the slot after bit selection for the slot, determining another start bit point of bit selection for a subsequent slot from an end bit of the bit selection for slot.

6. The method of claim 1, wherein the predetermined factor comprises one of:
a second number of bits for code block with an assumption that no uplink channel information is multiplexing with an uplink shared channel,
a third number of bits for the code block in a first slot among the first number of slots,
a fourth number of bits for the code block in one slot with a largest value when downlink control information (DCI) received from the network device, or
a fifth number of bits for the code block in the slot.

7. The method of claim 1, further comprising:
determining a data rate of the transport block based on a size of the transport block, a total number of code blocks for the transport block and a number of scheduled code blocks for the transport block; and
in accordance with a determination that the determined data rate exceeds a threshold data rate, causing a transmission of the transport block to be skipped.

8. The method of claim 7, wherein determining the data rate comprises:
determining the data rate by
$$V = \frac{TBS \times C 1}{N \times C} ,$$
wherein V represents the data rate, TBS represent the size of the transport block, C1 represents the number of scheduled code blocks, C represents the total number of code blocks, and N represents the first number of slots.

9. The method of claim 1, further comprising:
obtaining, at the terminal device, a configuration list which comprises a time domain resource allocation, wherein the time domain resource allocation comprises a set of first numbers and a set of numbers of repetitions for the transport block;
receiving, from the network device, a code indication in downlink control information; and
determining, based on the code indication, the first number and a sixth number of repetitions from the time domain resource allocation.

10. The method of claim 1, further comprising:
obtaining, at the terminal device, a configuration list which comprises a time domain resource allocation, wherein the time domain resource allocation comprises one of: a set of first numbers or a set of numbers of repetitions for the transport block;
receiving, from the network device, a code indication in downlink control information;
determining, based on the code indication, one of: the first number or a sixth number of repetitions from the time domain resource allocation; and
obtaining, at the terminal device, the other one of: the first number or a sixth number of repetitions from the time domain resource allocation.

11. A communication method, comprising:
transmitting, at a network device and to a terminal device, a configuration indicating that a transport block is transmitted over a first number of slots; and
receiving, from the terminal device, a set of selected bits from a bit selection circular buffer in a slot, wherein a start bit point from the bit selection circular buffer for the slot within the first number of slots is determined based on a redundancy version (RV) start indication, an index of the slot and a predetermined factor.

12. The method of claim 11, wherein the index of the slot starts from a predetermined number.

13. The method of claim 11, wherein the predetermined factor comprises one of:
a second number of bits for code block with an assumption that no uplink channel information is multiplexing with an uplink shared channel,
a third number of bits for the code block in a first slot among the first number of slots,
a fourth number of bits for the code block in one slot with a largest value when downlink control information (DCI) received from the network device, or
a fifth number of bits for the code block in the slot.

14. The method of claim 11, further comprising:
transmitting, to the terminal device, a configuration list which comprises a time domain resource allocation, wherein the time domain resource allocation comprises a set of first numbers or a set of numbers of repetitions for the transport block; and
transmitting, to the terminal device, a code indication in downlink control information, wherein the code indication corresponds to a configuration in the configuration list.

15. The method of claim 11, further comprising:
transmitting, to the terminal device, a configuration list which comprises a time domain resource allocation, wherein the time domain resource allocation comprises one of: a set of first numbers or a set of numbers of repetitions for the transport block;
receiving, from the network device, a code indication in downlink control information; and
determining, based on the code indication, one of: the first number or a sixth number of repetitions from the time domain resource allocation.

16. A terminal device comprising:
a processor; and
a memory coupled to the processor and storing instructions thereon, the instructions, when executed by the processor, causing the terminal device to perform the method according to any of claims 1 to 10.

17. A network device comprising:
a processor; and
a memory coupled to the processor and storing instructions thereon, the instructions, when executed by the processor, causing the network device to perform the method according to any of claims 11 to 15.

18. A computer readable medium having instructions stored thereon, the instructions, when executed on at least one processor, causing the at least one processor to perform the method according to any of claims 1 to 10 or any of claims 11 to 15.
